(19) United States
(12) Patent Application Publication
(10) Pub. No.: US 2014/0279069 A1
(43) Pub. Date: Sep. 18, 2014

(54) DETERMINING EFFECTIVENESS OF PROMOTING STORIES WITHIN A SOCIAL NETWORKING SYSTEM

(71) Applicant: Facebook, Inc., Menlo Park, CA (US)

(72) Inventors: Yigal Dan Rubinstein, Los Altos, CA (US); Abhishek Doshi, London (GB); Reshma Khilnani Ebberson, San Francisco, CA (US)

(73) Assignee: Facebook, Inc., Menlo Park, CA (US)

(21) Appl. No.: 13/836,828

(22) Filed: Mar. 15, 2013

(51) Int. Cl. G06Q 30/02

(52) U.S. Cl. CPC G06Q 30/0277
USPC 705/14.73

(57) ABSTRACT

A social networking system provides stories about objects in the social networking system to a viewing user. To increase the likelihood that a story will also be provided to other users, the social networking system allows the viewing user to promote the story. When a user promotes a story, the social networking system may monitor the effectiveness of the promotion. For example, the social networking system generates a ghost story corresponding to a promoted story and not associated with promotion information. When a promoted story is selected to be provided to a user, the social networking system determines whether the ghost story would have been selected to be provided to the user. If the ghost story would have been selected, the social networking system determines the promotion did not affect selection of the promoted story.

### BACKGROUND

This invention generally pertains to social networking, and more specifically to advertising via a social networking system.

Social networks, or social utilities that track and enable connections between users (including people, businesses, and other entities), have become prevalent in recent years and allow users to communicate information more efficiently. For example, a social networking system user may post contact information, background information, job information, hobbies, and/or other user-specific data to the social networking system. Other users can then review the posted data by browsing user profiles or searching for profiles including specific data. Social networking systems also allow users to associate themselves with other users, thus creating a web of connections among the users of the social networking system. These connections among the users can be leveraged by the social networking system to offer more relevant information to each user in view of user-stated interests.

Additionally, social networking systems enable users to interact with other users or objects by performing various actions. For example, users may post comments to pages associated with other users, view images, view video, listen to audio data or perform other actions on various objects maintained by the social networking system. Actions performed by a user are frequently distributed to other users connected to the user who performed the action. Often, social networking systems generate newsfeeds for their users, where various stories in the newsfeed describe actions performed by other users connected to the user viewing the newsfeed. A social networking system may prioritize stories in the newsfeed so that stories likely to be of interest to the viewing user are more readily accessible to the viewing user. For example, stories describing actions performed by users with whom the viewing user frequently interacts or describing actions performed on objects in which the user has a particular interest may be easier to view via the newsfeed.

Users may advertise products or events or otherwise communicate content to other users via a social networking system. For example, content may be described by stories indicating other users' interactions with the social networking system. These stories may be included in newsfeeds presented to social networking system users connected to users performing the interactions. As a user may have different levels of interactions with different social networking system users, the social networking system may determine that some users are not likely to be interested a story describing a user's interaction, which reduces the effectiveness of the social networking system in communicating content. Hence, users may seek to increase the likelihood of a particular story being presented to other social networking system users, allowing more effective communication of content.

### SUMMARY

Embodiments of the invention enable users to promote certain actions, posts, or other content that is represented in a social networking system. The promotions may take the form of “sponsored stories” or “promoted stories,” which may comprise a story delivered to a user of the social networking system about an interaction of one of the user's friends with a particular object in the system. To simplify promotion of sponsored stories, embodiments of the invention enable users to more easily generate requests for sponsored stories using interface controls that enable promotion of specific actions, posts, or other content viewable in an interface of the social networking system.

A social networking system allows a viewing user to receive descriptions of actions performed by other users connected to the viewing user or content associated with objects maintained by the social networking system. To communicate this information to the viewing user, the social networking system may generate a newsfeed for presentation to the viewing user. The newsfeed includes stories describing actions, objects or other content likely to be of interest to the viewing user. For example, the newsfeed includes stories describing actions performed by other users connected to the viewing user. Commonly, the social networking system will select stories for the newsfeed based on the likelihood that the viewing user will be interested in an action, object, user or other content identified by the stories. However, users may compensate the social networking system to increase the likelihood that stories selected by the user are included in the viewing user's newsfeed or that stories selected by the user are readily identified from the viewing user's newsfeed.

To increase awareness of an object, users may receive newsfeed stories describing interactions with the object by other users. Certain users of the social networking system may be authorized to promote the object or an action associated with the object (“promoting users”) by identifying content for distribution to other users. For example, a promoting user may customize how data about the object or action is distributed to other users. To increase the likelihood that social networking system users interact with the object, a user may customize or tailor how content associated with the object is distributed. For example, a user may specify a budget and/or bid amounts used to compensate the social networking system for placing stories associated with the object in newsfeeds of other users. As another example, a user may specify targeting criteria for content about the object to distribute the content to a particular group of users.

In some embodiments, the social networking system determines the how effective a promotion is in increasing access to a story. For example, the social networking system may determine whether a promoted story would have been selected for presentation to a user without being promoted to determine if the promotion contributes to the presentation of the promoted story. In one embodiment, the social networking system determines scores for various stories and selects stories for presentation based on the scores. A likelihood of a user being interested in a story and a bid amount associated with the story may be used to determine the story's score. When a promoted story is selected for presentation, the social networking system may determine an alternate score for the promoted story that is not based in part on the associated bid amount. The social networking system compares the alternate score to scores of other selected stories to determine if the promoted story would have been selected without being promoted. If the promoted story would have been selected based on its alternate score, the social networking system indicates the promoted story was organically selected; however, if the promoted story would not have been selected based on its alternate score, the social networking system indicates the promoted story was selected based on the promotion.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is an interaction diagram of a method for promoting a story in a social networking system, in accordance with an embodiment of the invention.

FIG. 2 is a high level block diagram illustrating a system environment suitable for operation of a social networking system, in accordance with an embodiment of the invention.

FIG. 3 is a block diagram of a social networking system, in accordance with an embodiment of the invention.

FIG. 4A is an example user interface for promoting a story on a social networking system page, in accordance with an embodiment of the invention.

FIG. 4B is a example of a promotion interface for receiving parameters for modifying distribution of a story to social networking system users, in accordance with an embodiment of the invention.

FIG. 4C is an example of a statistics interface showing statistics of a promoted story on a social networking system, in accordance with an embodiment of the invention.

FIG. 5 is a flow chart of a method for determining the effectiveness of promoting a story in a social networking system, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

FIG. 1 is an interaction diagram 100 of a method for promoting a story in a social networking system 110. Pages associated with different objects are stored and maintained by the social networking system, allowing social networking system users to access information about different objects by accessing a page associated with an object. For example, a page associated with an event object includes comments from users about the event, images associated with the event, information describing the event or other information associated with the event. In some embodiments, information about an object is presented as different stories in a newsfeed on the page associated with the event.

Social networking system users may be authorized to promote an object to other users. For example, a user authorized to promote an object (a “promoting user”) selected content associated with the object for distribution to other social networking system users. Examples of promoting users include: a page administrator for the page associated with the object, a creator of the object or the page or another user capable of modifying the object or the page associated with the object. Additionally, in some embodiments, a user may promote content posted to the social networking system 110 by the user or content posted to the social networking system 110 by another social networking system user. This allows various users to increase the likelihood of promoted content being presented to other social networking system users. A promoting user may also provide parameters specifying how selected content is distributed to other social networking system users. For example, the promoting user may associate targeting criteria with selected content to present the selected content to specific groups of users or to present the selected content for a specified duration. Parameters specifying distribution of selected content may also specify a budget and/or a bid amount to identify compensation provided to the social networking system for presenting the selected content to its users, allowing the promoting user to increase the likelihood that other users receive, or access, the selected content.

In the example of FIG. 1, a promoting user 105 requests 115 a page maintained by the social networking system 110 and associated with an object. For example, the promoting user 105 requests 115 a page associated with an event. However, in other embodiments, the promoting user 105 may request 115 any content provided by the social networking system 110, such as stories generated by the social networking system 110. Hence, content presented to the promoting user 105 other than a page may also be promoted. In one embodiment, the promoting user 105 selects a story from one or more stories, each describing content (e.g., an action or an object) posted to the social networking system by the promoting user 105 or another user connected to the promoting user 105, presented to the promoting user 105 by the social networking system 110. For example, a user may promote stories, or other objects, presented to the user by the social networking system 110 or may promote content provided to the social networking system 110 by the user.

Responsive to receiving the request, the social networking system 110 determines 125 whether the promoting user 105 is authorized to promote the object. The social networking system 110 maintains user profiles for its users that include demographic, and other, information about the users. A user profile may include data specifying whether a user is authorized to promote an object. For example, the user profile includes an object identifier associated with objects the user is authorized to promote, includes an object identifier and a flag indicating whether the user is authorize to promote the object or other suitable data. In some embodiments, the social networking system 110 accesses a user profile associated with the promoting user 105 and uses data in the user profile to determine 125 whether the promoting user 105 is authorized to promote the object associated with the requested page.

Responsive to the promoting user 105 being authorized to promote the object, the social networking system 110 transmits 130 the page 140 associated with the object and includes promotion functionality in the transmitted page 140, which includes one or more stories 142A, 142B, 142C (also referred to individually and collectively using reference number 142) associated with the object. For example, stories 142A, 142B, 142C include comments from social networking system users about the object, pictures associated with the object, links to external websites associated with the object, descriptions of social networking system user interactions with the object or with the page 140 or any other suitable data.

To allow the promoting user 105 to promote the object, the page 140 transmitted 130 to the promoting user 105 may include executable instructions that, when executed by a client device used by the promoting user 105, allow the page 140 to receive data from the promoting user 105 specifying a promotion of the object. The page 140 may be transmitted to other users that are not authorized to promote the object without the executable instructions described above. In the example of FIG. 1, the page 140 displays a promote option 145 associated with one or more of the displayed stories 142A, 142B, 142C proximate to the displayed stories 142A, 142B, 142C. While FIG. 1 shows a promote option 145 displayed proximate to each of the displayed stories 142A, 142B, 142C, in other embodiments the promote option 145 is displayed proximate to a subset of the displayed stories 142A, 142B, 142C. The promote option 145 may comprise a button, a link, an image or any other suitable user-accessible data. FIG. 4A, discussed in more detail below, illustrates an example story 142 having a promote option 145.

By accessing a promote option 145 associated with a displayed story 142A, 142B, 142C, the promoting user 105 is prompted for parameters used to promote the story 142 associated with the accessed promote option 145 to other social networking system users. In one embodiment, accessing the promote option 145 associated with a displayed story 142 presents a story promotion interface 150 to the promoting user 105. In FIG. 1, the promoting user 105 accesses the promote option 145 associated with the displayed story 142A, causing display of the story promotion interface 150 to allow the promoting user 105 to provide parameters for distributing the displayed story 142A to other social networking system users.

While FIG. 1 shows an embodiment where the promotion interface 150 is displayed in conjunction with the page 140, in other embodiments the promotion interface 150 may be displayed independently of the page 140 or may be displayed as a region within the page 140. For example, the promotion interface 150 may be a dialog box or a pop-up window displayed over a portion of the page 140. FIG. 4B, discussed in more detail below, illustrates an example promotion interface 150.

The promotion interface 150 identifies different parameters used by the social networking system 110 to distribute the story 142A to other users and allows the promoting user 105 to specify values for the different parameters. To simplify promotion of a story, or other content, the promotion interface 150 may display a subset of the parameters used by the social networking system 110 for story distribution, allowing the promoting user 105 to easily provide a smaller amount of parameters for modifying content distribution. Thus, rather than have the promoting user 105 provide a comprehensive set of parameters for distributing stories, the promotion interface 150 allows the promoting user 105 to provide a reduced amount of parameters for customizing content distribution. For purposes of illustration, the promotion interface 150 is described herein as receiving parameters used to promote a sponsored story; however, the promotion interface 150 may also receive parameters for promoting an advertisement, or other content, to social networking system users.

For example, the promotion interface 150 includes one or more fields 152A, 152B, 152C associated with types of parameters used by the social networking system 110 for content distribution. Examples of parameters associated with fields 152A, 152B, 152C in the promotion interface 150 include targeting criteria specifying one or more characteristics of users to receive the story associated with the accessed promote option, a budget for presenting the story associated with the accessed promote option to other users of the social networking system, a bid amount for compensating the social networking system 110 for presenting the story associated with the accessed promote button to other users a location associated with users to be presented the story associated with the accessed promote option, a time range for presenting the story associated with the accessed promote option to other users of the social networking system or other suitable parameters. FIGS. 4A and 4B provide further details about the page 140 and the promotion interface 150, respectively.

Parameters from the promoting user 105 received via the promotion interface 150 are transmitted to the social networking system 110, which subsequently uses the received parameters to generate a sponsored story request used to distribute an action and/or an object on which the story associated with the accessed promote button 150 is based. Embodiments of sponsored stories based on sponsored story requests are described in U.S. application Ser. No. 12/193,702, filed Aug. 18, 2008, published as U.S. Patent Application Publication No. 2009/0119167, which is incorporated in its entirety by reference herein. The sponsored story request allows the social networking system 110 to distribute the action or object to other users of the social networking system. For example, the sponsored story request is used by the social networking system 110 to generate a sponsored story that is distributed to a viewing user 120 that is connected to another user that performed the action specified by the generated sponsored story request. For purposes of illustration, FIG. 1 shows the social networking system 110 presenting 165 the story 142A associated with the accessed promote option 145 to a viewing user 120. If the promoting user 105 specifies targeting criteria via the promotion interface 150, the viewing user 120 is a social networking user having one or more of the characteristics specified by the targeting criteria.

In one embodiment, the viewing user 120 is presented 165 with the sponsored story produced by the sponsored story request corresponding to the story 142A associated with the accessed promote option 145 responsive to the viewing user 120 requesting content from the social networking system 110. For example, the viewing user 120 requests a newsfeed 170 including stories 172A, 172B describing actions by other users of the social networking system connected to the viewing user 120, and the story 142A associated with the accessed promote button 145 is also included in the newsfeed 170. The location of the story 142A in the newsfeed 170 may be based on an affinity of the viewing user 120 for a user, object or action included in the story 142A as well as compensation provided to the social networking system 110, specified by the promotion interface 150, for displaying the story 142, in addition to other factors. In other embodiments, the story 142A associated with the accessed promote button 145 may be presented responsive to a request for a page describing a user profile, a page describing a topic or entity in the social networking system 110 or other content maintained by the social networking system 110. While FIG. 1 shows presentation of the story 142A associated with the accessed promote button 145 in a newsfeed 170, the story 142A may be presented 165 via any suitable channel, such as via a notification, via a message or via a banner advertisement.

For example, a story 142 is a video of a movie trailer posted by the promoting user 105 or by a page administered by the promoting user 105. By accessing a promote option 145 associated with the story 142, the promoting user 105 may provide a bid amount, budget and/or targeting criteria used to generate a sponsored story request for the video via the promotion interface 150. When a user connected to the viewing user 120 interacts with the video, the social networking system 110 uses the sponsored story request generated by interaction with the promote button 145 and promotion interface 150 to generate a sponsored story presented to the viewing user 120 based on the action of the user connected to the viewing user 120. For example, if the user connected to the viewing user 120 commented on the video, the generated sponsored story may present “Friend A commented on the video. Click here to watch it yourself,” and may further identify the video by name or other descriptive information.

### System Architecture

FIG. 2 is a block diagram of a system environment 200 for a social networking system 110. The system environment 200 shown by FIG. 2 comprises one or more client devices 210, a network 220, one or more third-party systems 230, and the social networking system 110. In alternative configurations, different and/or additional components may be included in the system environment 200. The embodiments described herein can be adapted to online systems that are not social networking systems.

The client devices 210 are one or more computing devices capable of receiving user input as well as transmitting and/or receiving data via the network 220. In one embodiment, a client device 210 is a conventional computer system, such as a desktop or a laptop computer. Alternatively, a client device 210 may be a device having computer functionality, such as a personal digital assistant (PDA), a mobile telephone, a smartphone or another suitable device. A client device 210 is configured to communicate via the network 220. In one embodiment, a client device 210 executes an application allowing a user of the client device 210 to interact with the social networking system 110. For example, a client device 110 executes a browser application to enable interaction between the client device 210 and the social networking system 110 via the network 220. In another embodiment, a client device 210 interacts with the social networking system 110 through an application programming interface (API) running on a native operating system of the client device 210, such as IOS® or ANDROID™.

The client devices 210 are configured to communicate via the network 220, which may comprise any combination of local area and/or wide area networks, using both wired and/or wireless communication systems. In one embodiment, the network 220 uses standard communications technologies and/or protocols. For example, the network 220 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 220 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 220 may be represented using any suitable format, such as hypertext markup language (HTML) or extensible markup language (XML). In some embodiments, all or some of the communication links of the network 220 may be encrypted using any suitable technique or techniques.

One or more third party systems 230 may be coupled to the network 220 for communicating with the social networking system 110, which is further described below in conjunction with FIG. 3. In one embodiment, a third party system 230 is an application provider communicating information describing applications for execution by a client device 210 or communicating data to client devices 210 for use by an application executing on the client device. In other embodiments, a third party system 230 provides content or other information for presentation via a client device 210. A third party system 230 may also communicate information to the social networking system 110, such as advertisements, content, or information about an application provided by the third party system 230.

FIG. 3 is an example block diagram of an architecture of the social networking system 110. The social networking system 110 shown in FIG. 3 includes a user profile store 305, a content store 310, an action logger 315, an action log 320, an edge store 325, a newsfeed generator 330, a display generator 335, a promotion engine 340, and a web server 345. In other embodiments, the social networking system 110 may include additional, fewer, or different components for various applications. Conventional components such as network interfaces, security functions, load balancers, failover servers, management and network operations consoles, and the like are not shown so as to not obscure the details of the system architecture.

Each user of the social networking system 110 is associated with a user profile, which is stored in the user profile store 305. A user profile includes declarative information about the user that was explicitly shared by the user and may also include profile information inferred by the social networking system 110. In one embodiment, a user profile includes multiple data fields, each describing one or more attributes of the corresponding user of the social networking system 110. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the social networking system 110 displayed in an image. A user profile in the user profile store 305 may also maintain references to actions by the corresponding user performed on content items in the content store 310 and stored in the action log 320.

A user profile may also include data indicating whether a user is authorized to promote an object. For example, a user profile includes an object identifier or reference to the content store 310 identifying objects a user is authorized to promote or an object identifier associated with a flag or other indicator whose value indicates whether the user is authorized to promote. A user authorized to promote an object may identify content associated with the object for presentation to other social networking system users and may also specify parameters to regulate how content associated with the object is presented to the other social networking system users. Including promotion authorization data in a user's profile allows the social networking system 110 may quickly determine the amount of functionality to provide to a user accessing a page associated with an object. This allows the social networking system 110 to limit or prevent unauthorized users from distributing content associated with an object while allowing authorized users to promote the object through content distribution.

While user profiles in the user profile store 305 are frequently associated with individuals, allowing individuals to interact with each other via the social networking system 110, user profiles may also be stored for entities such as businesses or organizations. This allows an entity to establish a presence on the social networking system 110 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

The content store 310 stores objects that each represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 310, such as status updates, photos tagged by users to be associated with other objects in the social networking system, events, groups or applications. In some embodiments, objects are received from third-party applications or third-party applications separate from the social networking system 110. In one embodiment, objects in the content store 310 represent single pieces of content, or content “items.” Hence, users of the social networking system 110 are encouraged to communicate with each other by posting text and content items of various types of media through various communication channels. This increases the amount of interaction of users with each other and increases the frequency with which users interact within the social networking system 110.

The action logger 315 receives communications about user actions internal to and/or external to the social networking system 110, populating the action log 320 with information about user actions. Examples of actions include adding a connection to another user, sending a message to another user, uploading an image, reading a message from another user, viewing content associated with another user, attending an event posted by another user, among others. In addition, a number of actions may involve an object and one or more particular users, so these actions are associated with those users as well and stored in the action log 320.

The action log 320 may be used by the social networking system 110 to track user actions on the social networking system 110, as well as actions on third party systems XX30 that communicate information to the social networking system 110. Users may interact with various objects on the social networking system 110, and information describing these interactions is stored in the action log 320. Examples of interactions with objects include: commenting on posts, sharing links, and checking-in to physical locations via a mobile device, accessing content items, and any other interactions. Additional examples of interactions with objects on the social networking system 110 that are included in the action log 320 include: commenting on a photo album, communicating with a user, establishing a connection with an object, joining an event to a calendar, joining a group, creating an event, authorizing an application, using an application, expressing a preference for an object (“liking” the object) and engaging in a transaction. Additionally, the action log 320 may record a user's interactions with advertisements on the social networking system 110 as well as with other applications operating on the social networking system 110. In some embodiments, data from the action log 320 is used to infer interests or preferences of a user, augmenting the interests included in the user's user profile and allowing a more complete understanding of user preferences.

The action log 320 may also store user actions taken on a third party system XX30, such as an external website, and communicated to the social networking system 110. For example, an e-commerce website that primarily sells sporting equipment at bargain prices may recognize a user of a social networking system 110 through a social plug-in enabling the e-commerce website to identify the user of the social networking system 110. Because users of the social networking system 110 are uniquely identifiable, e-commerce websites, such as this sporting equipment retailer, may communicate information about a user's actions outside of the social networking system 110 to the social networking system 110 for association with the user. Hence, the action log 320 may record information about actions users perform on a third party system 230, including webpage viewing histories, advertisements that were engaged, purchases made, and other patterns from shopping and buying.

In one embodiment, the edge store 325 stores information describing connections between users and other objects on the social networking system 110 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 110, such as expressing interest in a page on the social networking system, sharing a link with other users of the social networking system, and commenting on posts made by other users of the social networking system.

In one embodiment, an edge may include various features each representing characteristics of interactions between users, interactions between users and object, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the social networking system 110, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 325 also stores information about edges, such as affinity scores for objects, interests, and other users. Affinity scores, or “affinities,” may be computed by the social networking system 110 over time to approximate a user's interest in an object, interest, and other users in the social networking system 110 based on the actions performed by the user. A user's affinity may be computed by the social networking system 110 over time to approximate a user's interest for an object, interest, or other user in the social networking system 110 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 325, in one embodiment. Alternatively, each interaction between a user and a specific object is stored as a separate edge. In some embodiments, connections between users may be stored in the user profile store 305, or the user profile store 305 may access the edge store 325 to determine connections between users.

In one embodiment, the social networking system 110 identifies stories likely to be of interest to a user through a “newsfeed” presented to the user. A story presented to a user describes an action taken by an additional user connected to the user and identifies the additional user. In some embodiments, a story describing an action performed by a user may be accessible to users not connected to the user that performed the action. The newsfeed manager 330 may generate stories for presentation to a user based on information in the action log 320 and in the edge store 325 or may select candidate stories included in the content store 310. One or more of the candidate stories are selected and presented to a user by the newsfeed manager 330.

For example, the newsfeed manager 330 receives a request to present one or more stories to a social networking system user. The newsfeed manager 330 accesses one or more of the user profile store 305, the content store 310, the action log 320, and the edge store 325 to retrieve information about the identified user. For example, stories or other data associated with users connected to the identified user are retrieved. The retrieved stories or other data are analyzed by the newsfeed manager 330 to identify content likely to be relevant to the identified user. For example, stories associated with users not connected to the identified user or stories associated with users for which the identified user has less than a threshold affinity are discarded as candidate stories. Based on various criteria, the newsfeed manager 330 selects one or more of the candidate stories for presentation to the identified user.

In various embodiments, the newsfeed manager 330 presents stories to a user through a newsfeed including a plurality of stories selected for presentation to the user. The newsfeed may include a limited number of stories or may include a complete set of candidate stories. The number of stories included in a newsfeed may be determined in part by a user preference included in user profile store 305. The newsfeed manager 330 may also determine the order in which selected stories are presented via the newsfeed. For example, the newsfeed manager 330 determines that a user has a highest affinity for a specific user and increases the number of stories in the newsfeed associated with the specific user or modifies the positions in the newsfeed where stories associated with the specific user are presented.

The newsfeed manager 330 may also account for actions by a user indicating a preference for types of stories and selects stories having the same, or similar, types for inclusion in the newsfeed. Additionally, newsfeed manager 330 may analyze stories received by social networking system 110 from various users to obtain information about user preferences or actions from the analyzed stories. This information may be used to refine subsequent selection of stories for newsfeeds presented to various users.

When generating a newsfeed, the newsfeed manager 330 may select or rank stories based on a variety of data. For example, stories may be ranked based on an affinity score between the user that the story is associated with and the user to whom the newsfeed is being generated. Additionally, the newsfeed manager 330 may account for bid amounts or budgets associated with a story by a promoting user and modify the likelihood of a story being included in a newsfeed based on the bid amounts and/or budget. Hence, the newsfeed manager 330 allows a promoting user, or an advertiser, to increase the likelihood that a story is included in a newsfeed by compensating the social networking system 110 for including the story in a newsfeed (i.e., allowing the user to “sponsor” the story). This allows users authorized to promote an object may provide the social networking system 110 with data customizing how interactions with the object are presented to different users.

In one embodiment, the newsfeed manager 330 identifies candidate stories for presentation to a viewing user and calculates a score for each of the candidate stories. The candidate stories may be ranked based on their corresponding scores with the ranking used to select stories for presentation to the viewing user. The score of a candidate story may be based on an organic value based on an affinity score and/or other measures of the likelihood of the viewing user having an interest in the score as well as a sponsored value based on the bid amount associated with the candidate story. For stories that are not sponsored, the sponsored value is zero, so the score of the story is the organic value.

When ranking or selecting stories, the newsfeed manager 330 may create a copy of a promoted story (also referred to as a “ghost story”) and calculate the score of the copy of the promoted story, which is the organic value of the promoted story. Using the copy of the promoted story and the ranking of candidate stories, the newsfeed manager 330 may determine whether the copy of the promoted story would be selected for presentation to the viewing user. If the copy of the promoted story has a score that would have warranted inclusion in the selected stories (e.g., the copy of the promoted story has at least a threshold score or has score resulting in at least a threshold ranking), the newsfeed manager 330 indicates the promoted story would have been presented; for example, the newsfeed manager 330 increments an organic count associated with the promoted story. However, if the copy of the promoted story does not have a score that would have warranted inclusion in the selected stories, the newsfeed manager 330 indicates the promoted story would not have been included in the selected stories without the promotion; for example, the newsfeed manager increments a promoted count associated with the promoted story. This allows the newsfeed manager 330 to provide information about the effectiveness of promoting a story to increase presentation of the story to users.

In some embodiments, the social networking system may keep track of other information regarding the distribution of the promoted story. For example, the social networking system may keep track of reach metrics that approximates the number of unique users performing a particular action on the story. Examples of reach metrics include viewing the story, sharing the story, expressing a preference of the story (“liking” the story), and the like. A detailed description of a method for tracking and visualizing the reach of a content can be found in U.S. patent application Ser. No. 13/689,441, titled “Visualizing Reach of Posted Content in a Social Networking System,” filed Nov. 29, 2012, the contents of which are incorporated by reference herein in its entirety.

The display generator 335 retrieves and displays content customized to a user viewing the content (a “viewing user”). For example, responsive to a request from a viewing user, the display generator retrieves a newsfeed from the newsfeed manager 330 and/or objects from the content store 310 and displays the retrieved content to the viewing user. The display generator 335 may provide a webpage or some other suitable display format to present content to the user via a client device 210. Additionally, the display generator 335 may generate a promotion interface 150 for receiving data used to modify distribution of content associated with an object from a user authorized to promote the object. In one embodiment, the display generator 335 also provides a promote option 145, as shown above in conjunction with FIG. 1, to a user authorized to promote an object when the user views data associated with the object. For example, the display generator 335 displays a button proximate to content associated with an object when a user authorized to promote the object views the content; this allows the user to interact with the button to promote the content to other users. Examples of content displayed by the display generator 335 are further described below in conjunction with FIGS. 4A and 4B.

The promotion engine 340 stores data for customizing distribution of content associated with the object. Data stored by the promotion engine 340 may be received via the promotion interface 150 provided by the display generator 335. For example, the promotion engine 340 accesses the user profile store 305 to identify users having one or more characteristics identified by targeting criteria stored in the promotion engine 340. As another example, the promotion engine 340 may also access stored budget information or bid amounts associated with stories, or other content, and provide the newsfeed manager 330 with the bid amounts and/or budgets for use in generating a ranked list of stories based on budget and/or bid amount. Additionally, the promotion engine 340 may request payment information from a promoting user for placing a bid amount associated with a story.

In some embodiments, the promotion engine 340 may communicate content associated with an object being promoted to client devices 210 of viewing users. For example, if the content is a sponsored story or other advertisement the promote engine 340 may serve the sponsored story based on data associated with it, such as targeting criteria, bid amount or similar data. Hence, the data provided by a user authorized to promote an object via the promotion interface 150 is stored and applied by the promotion engine 340 to modify presentation of content to viewing users. The promotion engine 340 may also provide a promoting user with information describing the effectiveness of story promotion based on information from the newsfeed manager 330. For example, the promotion engine provides information describing the difference between the number of times a promoted story has been presented to viewing users and the number of times the story would have been presented to viewing users without promotion. Determination of the effectiveness of story promotion is further described below in conjunction with FIG. 5.

The web server 345 links the social networking system 110 via the network 220 to the one or more client devices 210, as well as to the one or more third party systems 230. The web server 345 serves web pages, as well as other content, such as JAVA®, FLASH®, XML and so forth. The web server 345 may receive and route messages between the social networking system 110 and the client device 210, for example, instant messages, queued messages (e.g., email), text messages, short message service (SMS) messages, or messages sent using any other suitable messaging technique. A user may send a request to the web server 345 to upload information (e.g., images or videos) that are stored in the content store 310. Additionally, the web server 345 may provide application programming interface (API) functionality to send data directly to native client device operating systems, such as IOS®, ANDROID™, WEBOS® or RIM®.

### User Interface

FIG. 4A shows an example of a story 142 included on the page 140. As shown in FIG. 4A, the story 142 includes content associated with an object. In this example, the story 142 describes an event, although a story may include data about any type of object. For purposes of illustration, FIG. 4A shows a promote option 145, which is associated with the story, that is displayed proximate to the story 142 and associated with the story 142. As described above, the promote option 145 is displayed when the user viewing the page 140 is authorized to promote an object associated with the page 140, while the promote option 145 is not displayed if the user viewing the page 140 not authorized to promote the object associated with the page 140. In another embodiment, the promote option 145 is displayed to the user authoring or generating the story 142, but not to users that did not author or generate the story 142. Display of the promote option 145 may be further limited to social networking system entities that are a page or a brand or to social networking system users administering or creating the page or brand. While FIG. 4A shows the promote option 145 as the word “promote,” the promote option 145 may have any suitable appearance, such as an image, an icon or any other component capable of receiving input from the user.

Responsive to a user authorized to promote the object associated with the page 140 accessing the promotion option 145, a promotion interface 150, as shown in FIG. 4B, is presented to the user. The promotion interface 150 may be generated by the display generator 335 responsive to receiving an input that the promotion option 145 was accessed or may be generated by the client device 210 from which the page 140 is viewed executing instructions included in the page 140. The promotion interface 150 shown in FIG. 4B includes various fields associated with different data types, allowing a user to provide data by modifying the content of the fields. As described above, the promotion interface 150 is presented when a user authorized to promote an object associated with the page 140 accesses the promote option 145, but is not presented to users that are not authorized to promote the object.

In the example of FIG. 4B, the promotion interface 150 includes the story 142 associated with the accessed promote option 145, allowing the user to view the story 142 as it would be presented to other users and to readily identify the story 142 for which parameters being provided. The promotion interface 150 also includes fields for specifying parameters for distributing the story 142, such as targeting criteria and a budget. In one embodiment, the fields in the promotion interface 150 identify a subset of the parameters capable of being used to distribute the story, providing a user with a streamlined interface to expedite configuration of content distribution.

In the example of FIG. 4B the promotion interface 150 includes a budget field 420 allowing a user to specify a monetary amount used to compensate the social networking system 110 for distribution of the story 142. The user may provide compensation to the social networking system 110 to increase the likelihood that the story 142 is presented to the user, and the budget field 420 allows the user to specify a maximum amount for compensating the social networking system 110. The promotion interface 150 shown in FIG. 4B also includes one or more targeting fields for allowing a user to specify one or more targeting criteria identifying characteristics of users to be presented the story 142.

In FIG. 4B, various examples of targeting fields are shown, allowing a user to specify different targeting criteria. For example, a location field 425 allows a user promoting content to limit distribution of the story 142 to users with a location in their user profiles matching, or within a specified distance of, one or more locations identified by the location field 425. A duration field 430 allows a user to specify a time interval during which the story 142 is distributed to other users to limit promotion of the story. A gender/age field 435 allows a user to limit promotion of the story 142 to users having an age and/or gender in their user profiles matching data in the gender/age field 435. In one embodiment, the gender/age field 435 includes text boxes for receiving an age, age range and/or gender used to identify users to be presented the story 142. An audience field 440 receives data identifying additional criteria for identifying users to receive the story 142, such as whether users are fans of the page 140 or are friends with another user who is a fan of the page 140. An accept interface 445 receives an input confirming parameters entered into the promotion interface 150 while a cancel interface 450 receives an input discarding the parameters entered into the promotion interface and canceling promotion of the story 142 to other users.

In some embodiments, a promoting user may provide additional targeting criteria for limiting the distribution of the promoted story. For example, a user may limit the distribution of the story to users that “like” similar stories, to users connected to the promoting user and/or user connected to users that “like” the promoted content. In some embodiments, the user may also specify one or more users to whom the promoting user may want the sponsored story to be distributed to, or limit the distribution of the sponsored story to a plurality of selected users.

In some embodiments, a promoting user may specify a budget amount and/or a bid amount that will be used to the sponsored value of the score of the story. In other embodiments, the budget may be determined by the social networking system. For example, the social networking system may charge a $7 fix fee for promoting any story in the social networking system, or may determine a budget amount based on the targeting criteria specified by the user. The user may also specify other information such as an impression goal, and/or weightings for different performance categories (e.g., likelihood of interactions with the story, reach of the story, presence of social networking system functionality or context within the story, etc). In one embodiment, the social networking system may determine the bid amount needed to increase the number of views of the story based on the budget amount, the impression goal, and/or the weightings for the different performance categories as described in U.S. patent application Ser. No. 13/294,094, titled “Budget-Based Advertisement Bidding,” Nov. 10, 2011 and U.S. patent application Ser. No. 13/294,052, titled “Muti-Dimensional Advertisement Bidding,” filed Nov. 10, 2011, the contents of which are incorporated by reference herein in their entirety.

In one embodiment, after receiving the parameters for promoting the story 142, the user is prompted to provide payment information. For example, the user provides an account identifier for a financial account from which the social networking system 110 obtains the bid amount. The social networking system 110 may display a portion of previously received payment information or a portion of financial account information associated with the user to allow the user to easily provide the social networking system 110 with stored financial account information.

When a promoted story is presented to social networking system users, statistics describing performance of the promoted story may be presented. One example of a statistics interface 405 is shown in FIG. 4C. In some embodiments, access to the statistics interface 310 is limited to the user promoting the story 142. However, in other embodiments, the statistics interface 405 may be accessible to a user associated with an action in the story 142 or to any user viewing the story 142. The statistics interface 405 may presented in response to a user interacting with an interface element presented with the story 142. For example, interacting with an indication 410 the story has been promoted presents the statistics interface 405 to users authorized to view the statistics interface 405.

The statistics interface 405 may provide an indication of the effectiveness of promoting the story 142. For example, the statistics interface 405 indicates the percentage of views of the story 142 based on the promotion, and may also indicate the percentage of views of the story 142 occurring without the promotion. In one embodiment, the percentage of views of the story 142 occurring without promotion is based on the number of times the story would have been selected for presentation to users without the promotion. Determination of the effectiveness of story promotion is further described below in conjunction with FIG. 5. In other embodiments, the statistics interface 405 displays the number of times the story 142 was viewed because of the promotion, the number of times 142 the story was viewed without the promotion, or any other suitable statistics.

### Determining Effectiveness of Story Promotion

FIG. 5 illustrates one embodiment of a method for analyzing the effectiveness of promoting a story via the social networking system 110 promoted story. As described above, the newsfeed manager 330 identifies candidate stories for presentation to a viewing user and determines 501 a score for each of the candidate stories. The score for a candidate story is based on an organic value based on the likelihood of the viewing user being interested in the candidate story and may also have a promoted value based on the bid amount associated with the candidate story. For candidate stories that are not promoted, the candidate story's score is the organic value. Additionally, the newsfeed manager 330 generates copies of promoted stories included in the candidate stories, referred to as “ghost stories” associated with promoted stories, and determines 503 scores for the ghost stories. The scores for the ghost stories are based on the organic values of their corresponding promoted story but do not include the promoted value of the corresponding promoted story; hence, a ghost story's score accounts for the likelihood of a the viewing user having an interest in the corresponding promoted story but does not account for the bid amount or other compensation received for the corresponding promoted story.

Using the determined scores, the newsfeed manager 330 ranks 405 the candidate stories and selects 507 one or more of the candidate stories for presentation to the viewing user. For example, the newsfeed manager 330 selects 507 candidate stories having at least a threshold score or having at least a threshold ranking (e.g., the top 20 stories). The newsfeed manager 330 determines 509 if a promoted story is included in the selected candidate stories. For example, the newsfeed manager determines 509 if a selected story was identified in a sponsored story request received from a promoting user and stored by the social networking system 110.

If the newsfeed manager 330 determines 509 a promoted story is included in the selected candidate stories, to determine the effectiveness of the story promotion, the newsfeed manager determines whether the promoted story would have been selected 507 without the bid amount provided to the social networking system 100. In the embodiment shown by FIG. 5, if a promoted story is included in the selected candidate stories, the newsfeed manager 330 determines 511 whether the ghost story corresponding to the promoted story would be included in the selected candidate stories. Because the ghost story's score does not account for the promotion of the story, determination of whether the ghost story would be included in the selected candidate stories is based on the viewing user's likely interest in the ghost story. For example, the newsfeed manager 330 determines 511 if the score of the ghost story is greater than the score of at least one of the selected candidate stories or of the score of the ghost story is greater than the score of the selected candidate story having the lowest score. If the newsfeed manager 330 determines 511 the ghost story corresponding to the promoted story would be included in the selected candidate stories, the newsfeed manager 330 indicates 513 the promoted story included in the selected candidate stories would be organically selected. For example, the newsfeed manager 330 increments a counter of organic presentations of the promoted story. Thus, if the ghost story would have been included in the selected candidate stories, the promoted story would have been selected without being promoted, so the promotion did not contribute to the promoted story's selection.

However, if the newsfeed manager 330 determines 511 the ghost story would not have been included in the selected candidate stories, the newsfeed manager 330 indicates 515 the promotion of the story caused selection of the promoted story. For example, the newsfeed manager 330 increments a counter of promotion-based presentations of the promoted story. If the score of the ghost story corresponding to the promoted story is less than the scores of each of the selected candidate stories, the promoted story would not have been selected without the promotion value component of its score. As another example, if the score of the ghost story corresponding to the promoted story is less than the score of the selected candidate story having the lowest score, an indication 515 the promotion of the story caused selection of the promoted story is stored. Because the promotion value is based on the bid amount for the promoted story, promotion of the promoted story caused its inclusion in the selected candidate stories.

The promotion engine 340 may analyze information from the newsfeed manager 330 to describe the effectiveness of promotion of a story. For example, the promotion engine 340 may determine the ratio of a number of times a promoted story was indicated to be included in a newsfeed because of its promotion to a total number of times the promoted story was included in a newsfeed. As another example, the promotion engine 340 may determine a ratio of a number of times a promoted story was indicated to be included in a newsfeed because of its promotion to a total number of times the promoted story was indicated to be organically included in a newsfeed. Other suitable statistics may be determined by the promotion engine 340 to determine how effectively a story was promoted.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving a sponsored story request from a promoting user, the sponsored story request identifying a story associated with an action stored by the social networking system and providing one or more parameters including a bid amount;
generating a copy of the story identified by the sponsored story request;
receiving a request from a viewing user for presentation of one or more stories, each describing an action stored by the social networking system;
retrieving a plurality of candidate stories including the story identified by the sponsored story request;
determining a score for each of the candidate stories, a score for the story identified by the sponsored story request based at least in part on the bid amount of the sponsored story request;
determining a score for the copy of the story identified by the sponsored story request that is not based the bid amount of the sponsored story request;
selecting one or more stories for presentation to the viewing user based at least in part on the determined scores for each of the candidate stories;
if the story identified by the sponsored story request is included in the selected one or more stories, determining whether the copy of the story identified by the sponsored story request would be included in the selected one or more stories based on the score of the copy of the story identified by the sponsored story request;
determining a statistic based at least in part on whether the story identified by the sponsored story request is included in the selected one or more stories and whether the copy of the story identified by the sponsored story request would be included in the selected one or more stories; and
storing the determined statistic.

2. The method of claim 1, wherein determining whether the copy of the story identified by the sponsored story request would be included in the selected one or more stories based on the score of the copy of the story identified by the sponsored story request comprises:
storing data indicating the copy of the story identified by the sponsored story request would be included in the selected one or more stories if the score of the copy of the story identified by the sponsored story request is greater than at least one score of a story in the selected one or more stories.

3. The method of claim 2, wherein determining whether the copy of the story identified by the sponsored story request would be included in the selected one or more stories based on the score of the copy of the story identified by the sponsored story request further comprises:
storing data indicating the copy of the story identified by the sponsored story request would be not included in the selected one or more stories if the score of the copy of the story identified by the sponsored story request is less than scores of each story in the selected one or more stories.

4. The method of claim 1, wherein determining whether the copy of the story identified by the sponsored story request would be included in the selected one or more stories based on the score of the copy of the story identified by the sponsored story request comprises:
identifying a selected story having a lowest score;
storing data indicating the copy of the story identified by the sponsored story request would be included in the selected one or more stories if the score of the copy of the story identified by the sponsored story request is greater than a score of the identified selected story.

5. The method of claim 4, wherein determining whether the copy of the story identified by the sponsored story request would be included in the selected one or more stories based on the score of the copy of the story identified by the sponsored story request further comprises:
storing data indicating the copy of the story identified by the sponsored story request would be not included in the selected one or more stories if the score of the copy of the story identified by the sponsored story request is less than the score of the identified selected story.

6. The method of claim 1, wherein determining the statistic based at least in part on whether the story identified by the sponsored story request is included in the selected one or more stories and whether the copy of the story identified by the sponsored story request would be included in the selected one or more stories comprises:
incrementing a number of times the story identified by the sponsored story request was promoted if the copy of the story identified by the sponsored story request would not be included in the selected one or more stories; and
incrementing a number of times the story identified by the sponsored story request was organically selected if the copy of the story identified by the sponsored story request would be included in the selected one or more stories.

7. The method of claim 6, wherein determining the statistic based at least in part on whether the story identified by the sponsored story request is included in the selected one or more stories and whether the copy of the story identified by the sponsored story request would be included in the selected one or more stories further comprises:
determining a ratio of the number of times the story identified by the sponsored story request was promoted to the number of times the story identified by the sponsored story request was organically selected.

8. The method of claim 6, wherein determining the statistic based at least in part on whether the story identified by the sponsored story request is included in the selected one or more stories and whether the copy of the story identified by the sponsored story request would be included in the selected one or more stories further comprises:
determining a total of the number of times the story identified by the sponsored story was promoted and the number of times the story identified by the sponsored story was organically selected; and
determining a ratio of the number of times the story identified by the sponsored story request was promoted to the total.

9. A method comprising:
receiving a sponsored story request from a promoting user, the sponsored story request identifying a story associated with an action stored by the social networking system and providing one or more parameters including a bid amount;
receiving a request from a viewing user for presentation of one or more stories, each describing an action stored by the social networking system;
retrieving a plurality of candidate stories including the story identified by the sponsored story request;
determining a score for each of the candidate stories, a score for the story identified by the sponsored story request based at least in part on the bid amount of the sponsored story request;
selecting one or more stories for presentation to the viewing user based at least in part on the determined scores for each of the candidate stories;
if the story identified by the sponsored story request is included in the selected one or more stories, determining whether the story identified by the sponsored story request would be included in the selected one or more stories without the bid amount of the sponsored story request;
determining a statistic based at least in part on whether the story identified by the sponsored story request would be included in the selected one or more stories without the bid amount; and
storing the determined statistic.

10. The method of claim 9, wherein determining whether the story identified by the sponsored story request would be included in the selected one or more stories without the bid amount of the sponsored story request comprises:
determining an alternative score for the story identified by the sponsored story request that is not based at least in part on the bid amount of the sponsored story request;
storing data indicating the story identified by the sponsored story request would be included in the selected one or more stories if the alternative score of the story identified by the sponsored story request is greater than at least one score of a story in the selected one or more stories.

11. The method of claim 10, wherein determining whether the story identified by the sponsored story request would be included in the selected one or more stories without the bid amount of the sponsored story request further comprises:
storing data indicating the story identified by the sponsored story request would be not included in the selected one or more stories if the alternative score of the story identified by the sponsored story request is less than scores of each story in the selected one or more stories.

12. The method of claim 9, wherein determining whether the story identified by the sponsored story request would be included in the selected one or more stories without the bid amount of the sponsored story request comprises:
determining an alternative score for the story identified by the sponsored story request that is not based at least in part on the bid amount of the sponsored story request;
identifying a selected story having a lowest score;
storing data indicating the story identified by the sponsored story request would be included in the selected one or more stories if the alternative score of the story identified by the sponsored story request is greater than a score of the identified selected story.

13. The method of claim 12, wherein determining whether the story identified by the sponsored story request would be included in the selected one or more stories without the bid amount of the sponsored story request further comprises:
storing data indicating the story identified by the sponsored story request would be not included in the selected one or more stories if the alternative score of the story identified by the sponsored story request is less than the score of the identified selected story.

14. The method of claim 9, wherein determining the statistic based at least in part on whether the story identified by the sponsored story request would be included in the selected one or more stories without the bid amount comprises:
incrementing a number of times the story identified by the sponsored story request was promoted if the story identified by the sponsored story request would not be included in the selected one or more stories without the bid amount; and
incrementing a number of times the story identified by the sponsored story request was organically selected if the story identified by the sponsored story request would be included in the selected one or more stories without the bid amount.

15. The method of claim 14, wherein determining the statistic based at least in part on whether the story identified by the sponsored story request would be included in the selected one or more stories without the bid amount further comprises:
determining a ratio of the number of times the story identified by the sponsored story request was promoted to the number of times the story identified by the sponsored story request was organically selected.

16. The method of claim 14, wherein determining the statistic based at least in part on whether the story identified by the sponsored story request would be included in the selected one or more stories without the bid amount further comprises:
determining a total of the number of times the story identified by the sponsored story was promoted and the number of times the story identified by the sponsored story was organically selected; and
determining a ratio of the number of times the story identified by the sponsored story request was promoted to the total.

17. A method comprising:
presenting one or more stories to a user of a social networking system, each story associated with the user or with an additional user connected to the user;
receiving, from the user of a social networking system, a request to promote a story from the presented one or more stories, the story including content posted to the social networking system by the user or by an additional user connected to the user;
prompting the user to provide one or more parameters for defining a sponsored story request associated with at least one of the action and the object in the story, the one or more parameters including a bid amount;
receiving the one or more parameters from the user for defining the sponsored story request; and
storing the sponsored story request in a database, the sponsored story request defining a condition for providing a sponsored story to a viewing user who has a connection in the social networking system to another user who has interacted with at least one of the action and the object, the sponsored story describing the other user's interaction with at least one of the action and the object.

18. The method of claim 17, wherein receiving, from the user of the social networking system, the request to promote the story from the presented one or more stories comprises:
receiving an input from the user accessing a promote option associated with the story and displayed with the story.

19. The method of claim 17, wherein the content posted to the social networking system is an action performed by the user.

20. The method of claim 17, wherein the content posted to the social networking system is an action performed by an additional user of the social networking system connected to the user.
